(19) United States
(12) Patent Application Publication
(10) Pub. No.: US 2024/0097165 A1
(43) Pub. Date: Mar. 21, 2024

(54) METHOD FOR OPERATING A FUEL CELL, AND FUEL CELL SYSTEM

(71) Applicant: Schaeffler Technologies AG & Co. KG, Herzogenaurach (DE)

(72) Inventors: Nico Alexander Mattes, Karlsruhe (DE); Jan Haussmann, Weingarten (DE)

(73) Assignee: Schaeffler Technologies AG & Co. KG, Herzogenaurach (DE)

(21) Appl. No.: 18/275,176

(22) PCT Filed: Jan. 13, 2022
(86) PCT No.: PCT/DE2022/100027

§ 371 Date: Jul. 31, 2023

(30) Foreign Application Priority Data
Feb. 1, 2021 (DE) 102021102196.0

(51) Int. Cl. H01M 8/04746; H01M 8/04082; H01M 8/04089; H01M 8/04537

(52) U.S. Cl. CPC H01M 8/04753; H01M 8/04089; H01M 8/04201; H01M 8/04611; H01M 8/04776

(57) ABSTRACT

A method for operating a fuel cell. The fuel cell is supplied with gaseous fuel via an anode-side gas feed line and with air via a cathode-side gas feed line. The anode-side gas feed line and the cathode-side gas feed line are coupled via a pressure-transmitting element, wherein in the event of an increased power requirement of the fuel cell, the gas pressure of the anode-side gas feed line is at least partly transmitted to the cathode-side gas feed line via the pressure-transmitting element and causes the gas pressure of the cathode-side gas feed line to increase. A fuel cell system having at least one fuel cell, an anode-side gas feed line, a cathode-side gas feed line, and a monitoring unit.

### CROSS-REFERENCE TO RELATED APPLICATIONS

This application is the U.S. National Phase of PCT Appln. No. PCT/DE2022/100027, filed Jan. 13, 2022, which claims the benefit of German Patent Appln. No. 102021102196.0, filed Feb. 1, 2021, the entire disclosures of which are incorporated by reference herein.

### TECHNICAL FIELD

The disclosure relates to a method for operating a fuel cell, wherein gaseous fuel is supplied to the fuel cell via a gas feed line on the anode side and air is supplied via a gas feed line on the cathode side. Furthermore, the disclosure relates to a fuel cell system, having at least one fuel cell, a gas feed line on the anode side, a gas feed line on the cathode side and a control unit.

### BACKGROUND

Electrochemical cells known from the prior art are generally based on an assembly of two electrodes, which are connected to one another in a conducting manner by an ion conductor. An important design here is, for example, polymer electrolyte membrane fuel cells (PEM-FC), in which the ion conductor is formed by a proton-permeable polymer membrane (PEM, “proton exchange membrane” or “polymer electrolyte membrane”), through which the hydrogen ions formed at the anode migrate to the cathode and there react with the oxygen reduced at the cathode to form water. Irrespective of the design, the fuel cell must be continuously supplied with fuel (e.g., hydrogen) and the oxidizing agent (oxygen) to maintain the electrochemical reaction. In PEM cells and other common types of fuel cells, the reactants are usually supplied as a gas. The gases are fed into the cell in a hyper-stoichiometric ratio to ensure the supply even at high current densities, wherein the unused residual gas is discharged again at the gas outlet of the fuel cell stack.

If the current density changes over time, as occurs in particular when there is a change in load, a corresponding change in the reaction rate and thus a higher or lower gas quantity is required. The amount of gas supplied is provided on the anode side from a pressure tank and adjusted, for example, via a passive or active hydrogen pump and is provided on the cathode side by an air compressor. Because the gaseous fuel is available under increased pressure, the required amount of gas on the anode side can be set much more quickly than on the cathode side, where the compressor first must raise the ambient air to a higher pressure level. If the current density on the fuel cell stack is changed from a lower to a higher value, the amount of gas in the direction of the gas outlet may no longer be sufficient. This can lead to lower power and locally to low electrical potentials in the individual cells, which accelerates the degradation of the cell materials. To counteract this effect, the current density in such fuel cell systems is usually not changed abruptly, but is increased continuously over a certain period of time. However, this severely limits the rate of change of power over time. The dynamic load change is therefore largely dependent on the dynamics of the air compressor. Faster load changes can usually only be covered with fuel cell battery hybrid concepts.

For this purpose, DE 10 2014 211 791 A1 discloses a supply system in which load fluctuations are compensated for by a pressure accumulator so that the air flow is decoupled from the operating point of the compressor by being temporarily stored in the pressure accumulator. Further fuel cell systems having pressure accumulators are known, for example, from EP 2 521 210 B1 and DE 10 2009 040 177 A1.

### SUMMARY

Against this background, the object is to provide a method for operating a fuel cell that enables an accelerated increase in power over time and thus improves the possible applications of the fuel cell system.

The object is achieved by a method for operating a fuel cell wherein the gaseous fuel is supplied to the fuel cell via a gas feed line on the anode side and air is supplied via a gas feed line on the cathode side, wherein the gas feed line on the anode side and the gas feed line on the cathode side are coupled via a pressure-transmitting element, wherein an increased power requirement for the fuel cell transmits a gas pressure of the anode-side gas feed line at least partially to the cathode-side gas feed line via the pressure-transmitting element, and causes an increase in gas pressure of the cathode-side gas feed line.

A cell stack (stack) formed from a plurality of fuel cells is preferably operated with the method according to the disclosure. The fuel cell or fuel cells can in particular be hydrogen-oxygen fuel cells such as polymer electrolyte membrane fuel cells.

Compared to the prior art, the higher pressure on the anode side is used with the aid of the pressure-transmitting element between the fuel side and the air side (i.e., the anode-side or cathode-side gas feed line) to provide an additional volume flow on the air side. In this way, the dynamics of the fuel cell system are advantageously improved and its maximum power is increased. The gaseous fuel is preferably provided by a pressure tank. The air flow is preferably supplied from the ambient air, subjected to increased pressure by a compressor and then fed into the fuel cell. In particular, when there is an increased power requirement for the fuel cell, the compressor is operated at a higher power level, so that the correspondingly more compressed air can be fed into the fuel cell at increased pressure. Until the desired higher compressor power is achieved, the required pressure increase is generated at least partially or completely by the pressure-transmitting element, so that the changeover to a higher pressure can advantageously take place much more quickly. In this way, the time can be bridged, especially in the case of load jumps from low to high load, until the air compressor can supply the required higher air quantity and this has reached the inlet of the fuel cell. Due to the faster supply of atmospheric oxygen, the fuel cell can cope with load changes in a shorter time without an undersupply of oxygen occurring. Such an undersupply can lead to local degradation effects, particularly on the catalyst layer, and thus have a negative impact on the service life of the fuel cell stack. In the method according to the disclosure, the additional air quantity required for a load jump from low to high load can be provided exclusively via the volume available in the pressure-transmitting element or through an interaction of the pressure-transmitting element and an additional pressure accumulator (see below).

For the pressure transmission from the anode-side to the cathode-side gas feed line, in particular a first volume filled with gaseous fuel is increased and a second volume filled with air is correspondingly reduced, so that the pressure in the first volume decreases while the pressure in the second volume increases. The pressure transmission preferably takes place only during a transitional phase in which the compressor power of the compressor adjusts to a higher value, i.e., until the desired pressure increase of the cathode-side gas feed line can be achieved by the compressor alone. In addition, the unused fuel gas removed from the fuel cell is preferably pumped back in the direction of the fuel cell by a recirculation pump (e.g., a free-jet pump) and in particular combined with the fuel gas newly introduced from the pressure tank.

The pressure-transmitting element preferably has a flexible membrane or a displaceable piston. During the pressure transmission, in particular, a first volume filled with gaseous fuel is increased and a second volume filled with air is reduced, wherein the membrane arranged between the two volumes is elastically deformed or the piston is displaced accordingly.

A preferred embodiment of the disclosure provides that the gas pressure of the gas feed line on the cathode side is additionally increased when the power requirement is increased by admitting compressed air from a pressure accumulator. If mass flow balancing or an increase in mass flow is required over a longer period of time, the pressure accumulator can be used in addition to the pressure-transmitting element. The additional pressure accumulator is preferably arranged close to the supply to the fuel cell, and can be controlled via valves and filled with air by the compressor. In this way, the air stored in the pressure vessel can be added to the fuel cell for air supply in periods of high load or when the load changes over time. Compared to the exclusive use of the pressure-transmitting element, the pressure accumulator increases the amount of air that can be stored and also enables a further increase in the pressure of the stored air.

After the increased power demand has ended, the pressure accumulator is preferably refilled until a target pressure of the pressure accumulator is reached, wherein an air pressure of the pressure accumulator is increased in particular in stages up to the target pressure. The filling process must be carried out during operation, especially at low loads, to ensure the supply of air and the further operation of the fuel cell at the same time. In this case, a pressure-connecting line to the anode-side gas feed line can be produced in particular via a valve circuit and the higher pressure prevailing there can be transmitted to the pressure accumulator via the pressure-transmitting element. Once the pressure charging process is complete, the valve circuit can be changed again so that the air at higher pressure is made available to the fuel cell stack. This preferably takes place precisely when there is a change in load from a low load to a higher load.

The anode-side gas feed line preferably has a high-pressure section and a low-pressure section, wherein the pressure-transmitting element is connected to the high-pressure section via a first valve, and to the low-pressure section, via a second valve, wherein the first valve is opened and the second valve is closed to transmit the gas pressure from the anode-side gas feed line to the cathode-side gas feed line. The high-pressure section is preferably the region of the anode-side gas feed line in which the pre-expansion of the gaseous fuel takes place. For example, this high-pressure section can be arranged in the gas path immediately after an outlet valve of the fuel tank, while the low-pressure section is arranged immediately before the inlet to the fuel cell. In this way, the pressure transmission can be controlled via a targeted opening or closing of the first and second valve.

Preferably, after the gas pressure of the anode-side gas feed line has been transmitted to the cathode-side gas feed line, the first valve is closed and the second valve is opened and, in particular, gaseous fuel is supplied to the fuel cell from a section between the first and second valve through the second valve.

A preferred embodiment of the disclosure provides that, to refill the pressure accumulator, the gas pressure of the anode-side gas feed line is at least partially transmitted to the pressure accumulator by the pressure-transmitting element, wherein the cathode-side gas feed line has in particular an accumulator section which is connected to the pressure-transmitting element via a third valve, is connected to the fuel cell via a fourth valve, and is connected to the pressure accumulator via a fifth valve, wherein the fourth valve is closed and the fifth valve is opened to refill the pressure accumulator in a first filling step with the third valve open, wherein the gas pressure of the anode-side gas feed line is at least partially transmitted by the pressure-transmitting element to the pressure accumulator via the accumulator section, wherein the fourth valve is opened and the fifth valve is closed in a second filling step. The first filling step and the second filling step are preferably repeated so that the pressure accumulator is filled in stages up to the target pressure.

Preferably, after the pressure accumulator has been refilled, the third valve is closed and the fifth valve is opened to admit compressed air from the pressure accumulator.

According to a particularly preferred embodiment, the refilling is realized by an interaction of the first and second valve of the anode-side gas feed line with the third, fourth, and fifth valve of the cathode-side gas feed line: initially the first and fifth valves are closed while the second, third, and fourth valves are open. In the first filling step, the second and fourth valves are closed and the first and fifth valves are opened. This leads in particular to an increase in pressure in that part of the pressure-transmitting element which faces the anode-side gas feed line, wherein this increased pressure is transmitted to the cathode-side gas feed line and there forces air into the pressure accumulator. In the second filling step, the first and fifth valves are closed and the second and fourth valves are opened again, as a result of which pressure differences in the pressure-transmitting element in particular can be equalized. The first and second filling step can be repeated several times depending on the desired target pressure in the pressure vessel. Preferably, the third valve is then closed. If there is now an increased power requirement for the fuel cell, the fifth valve can be opened and the air from the pressure accumulator can be used to supply the fuel cell. Finally, if the compressor delivers the required amount of air at the inlet of the fuel cell, the air flow from the pressure vessel is reduced. Then the fifth valve can be closed and the third valve opened. The process of filling the air reservoir and increasing the pressure can then begin all over again.

It is preferably provided that the air in the cathode-side gas feed line is pressurized by a compressor, wherein operation of the compressor (with an increased compressor power) causes a further additional increase in the gas pressure of the cathode-side gas feed line. This results in a further function of the pressure accumulator unit for operation at maximum power requirement. For a short-term increase in fuel cell power (“boost function”), an increased air mass flow can be made available to the fuel cell for a short time by the compressor running at full load and additional air being fed into the system from the pressure accumulator.

An air pressure at an inlet of the fuel cell is preferably limited by a pressure regulator or a self-regulating element, in particular an orifice. A regulator or a self-regulating apparatus, such as an orifice plate, ensures that the pressure at the inlet of the fuel cell is limited and a controlled supply of atmospheric oxygen is thus guaranteed. If the air compressor has reached the desired quantity of air to be conveyed after the load change, the quantity of air provided from the pressure vessel decreases again due to the regulator or the self-regulating apparatus.

Another object of the disclosure is a fuel cell system having at least one fuel cell, an anode-side gas feed line, a cathode-side gas feed line, and a control unit, wherein a pressure-transmitting element is arranged between the anode-side and the cathode-side gas feed line, wherein the control unit is configured for this when there is an increased power requirement to transmit to the fuel cell a gas pressure from the anode-side gas feed line via the pressure-transmitting element at least partially to the cathode-side gas feed line, and to cause an increase in gas pressure of the cathode-side gas feed line. The fuel cell system preferably has a cell stack formed from a plurality of fuel cells. The fuel cell or fuel cells can in particular be hydrogen-oxygen fuel cells such as polymer electrolyte membrane fuel cells.

The same advantages and configurations result for the fuel cell system according to the disclosure as were described in relation to the method according to the disclosure.

According to such an advantageous embodiment, the fuel cell system has a pressure accumulator and the control unit is configured to bring about an additional increase in the gas pressure of the cathode-side gas feed line at the increased power requirement by admitting compressed air from a pressure accumulator.

### BRIEF DESCRIPTION OF THE DRAWINGS

Further details and advantages of the disclosure will be explained below with reference to the exemplary embodiment shown in the drawings. In the figures:

FIG. 1 shows a fuel cell system from the prior art in a schematic representation;

FIG. 2 shows an exemplary embodiment of the fuel cell system according to the disclosure in a schematic representation;

FIG. 3 shows a further exemplary embodiment of the fuel cell system according to the disclosure in a schematic representation.

### DETAILED DESCRIPTION

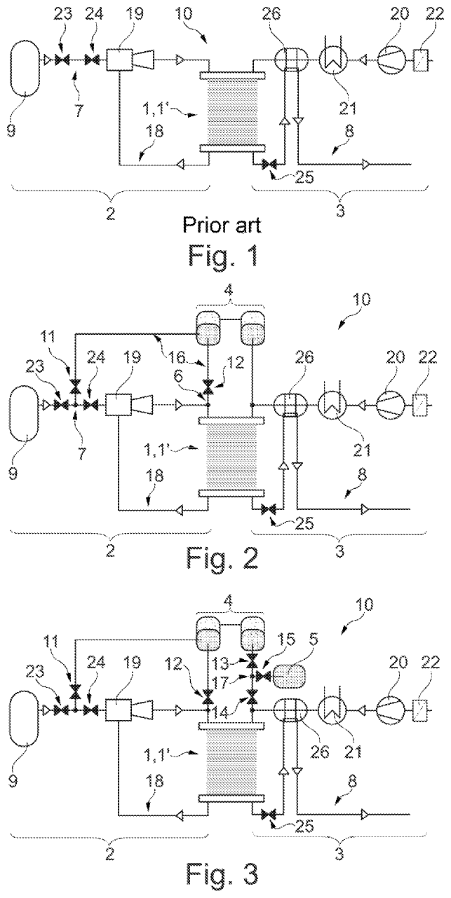

A fuel cell system 10 known from the prior art is shown schematically in FIG. 1. The core of the system 10 is the cell stack 1′ formed from a plurality of fuel cells 1 (e.g., polymer electrolyte membrane fuel cells), in which the electrochemical reactions for generating the electrical power take place. The reactants involved are transported to the fuel cell stack 1′ and fed into the cells 1 via a gas feed line 2 on the anode side and a gas feed line 3 on the cathode side. On the anode side, the gaseous fuel, here in particular hydrogen gas, is admitted from a pressure tank 9 and initially pre-expanded in a section 7 arranged between two valves 23, 24. A typical value of the hydrostatic pressure in the pressure tank 9 is 700 bar, for example, while the gas has a pressure of 10 to 50 bar after the pre-expansion. The pre-expanded fuel gas is fed to the fuel cell 1, where hydrogen ions are generated at the anode of the fuel cell 1, which migrate to the cathode and react there with oxygen to form water. To ensure sufficient a gas supply even at high current densities, fuel and oxygen are supplied in a hyper-stoichiometric proportion. The unused portion of the fuel flows back to the fuel cells via the recirculation system 18, wherein this recirculating circuit is driven via a recirculation pump 19, here via a free-jet pump.

To make the oxygen available for the reaction, ambient air is fed to the fuel cells 1 via the gas feed line 3 on the cathode side. The air first flows through a filter 22 and is pressurized by an air compressor 20. The pressurized air is then passed through an intercooler 21 and enriched in the humidifier 26 with additional humidity. The air is then fed into the cells 1, where the oxygen in the air reacts with the hydrogen ions at the cathode to form water, which is discharged via the valve 25 together with the unused remainder of the air. The water produced at the cathode is used here to provide the moisture for the humidifier 26 by the draining part 8 of the system being passed over the humidifier 26, where the outflowing air carrying the water produced transports the moisture to the inflowing air.

In the event of an increased power requirement for the fuel cells 1 (i.e., when there is a change in load from low to high load), more hydrogen and oxygen must be fed to the cells 1 accordingly to achieve the higher current density. While the hydrogen gas is provided via the pressure tank 9 and is therefore available relatively quickly under higher pressure, the cathode-side gas feed line 3 with the compressor 20 reacts much more slowly to the changeover. Both the dynamics of the air compressor 20 itself and the length of the air path and the number of components from the compressor 20 to the stack 1′ limit the control time considerably so that the gas feed line 3 can only react to the increased demand with a certain delay. This limits the power provided during the load change and at maximum power of the fuel cell stack.

FIG. 2 shows a further exemplary embodiment of a fuel cell system 10 according to the disclosure. A pressure-transmitting element 4 is arranged between the anode-side and the cathode-side gas feed lines 2, 3 (hydrogen side and air side). This element 4 can be a membrane or another pressure-transmitting component, for example. On the hydrogen side, the pressure-transmitting element 4 has a switchable connection to the high-pressure area 7 via a first valve 11 (here the medium-pressure area between the hydrogen tank 9 and the fuel cell stack 1′). In addition, there is a switchable connection between the hydrogen side of the pressure-transmitting element 4 and an area 6 of lower pressure in the hydrogen system 2 via the second valve 12. The air side of the pressure-transmitting element 4 is optionally connected to the air supply of the fuel cell stack 1′ via a pressure-regulating element. In phases of low and medium load requirements, the first valve 11 is closed and the second valve 12 is open and the pressure transmission system is in the starting position. If a higher load of the fuel cell 1 is now required, the second valve 12 is closed and the first valve 11 is opened. This increases the pressure on the hydrogen side in the pressure-transmitting element 4. This leads to an air flow from the air side of the pressure-transmitting element 4 into the fuel cell stack 1′. If necessary, another valve can be provided between the air side of the pressure-transmitting element 4 and the connection to the stack 1′, through which the processes of pressure build-up and air supply to the stack 1′ can be decoupled over time. After the load jump has taken place, the first valve 11 is closed and the second valve 12 is opened. The residual quantity of hydrogen at higher pressure can escape from section 16 into region 6 of lower pressure in the hydrogen system through second valve 12, optionally via a further pressure-regulating element. As soon as the pressure conditions on the hydrogen and air sides are balanced, the pressure transmission system is back in the starting position.

A second exemplary embodiment of the fuel cell system 10 according to the disclosure is shown schematically in FIG. 3. In addition to the described components according to the first exemplary embodiment, an additional pressure vessel 5 is provided on the air side 3. This pressure vessel 5 is connected to the air line 17 which is located between the air side of the pressure-transmitting element 4 and the air supply of the fuel cell stack 1′. A valve 14 (fourth valve) is connected directly to the pressure vessel 5. A third valve 13 is located in the air path directly on the air side of the pressure-transmitting element 4. In addition, in this variant of the fuel cell system 10 according to the disclosure, a fifth valve 15 is arranged upstream of the connection of the pressure transmission system 4 to the air supply to the fuel cell stack 1′. It is expedient to regulate or limit the air pressure at this point by regulating the valve position of the fifth valve 15 or by another element regulating or limiting the pressure or volume flow, e.g., an orifice, to reduce pressure fluctuations and so as not to exceed the permissible pressure range of the fuel cell stack 1′.

In the second variant of the fuel cell system 10 according to the disclosure, the pressure transmission is implemented in four steps as follows:
(a) In normal operation, the first and fifth valves 11, 15 are closed and the second, third, and fourth valves 12, 13, 14 are opened. The same or a similar pressure as on the air side is present in the pressure vessel 5 and the fuel cell 1 is operated at a low or constant, non-maximum load.
(b) Thereafter, the pressure charging process is carried out. First, valves 12 and 14 are closed. Then, valve 11 and valve 15 are opened. This leads to an increase in the pressure on the hydrogen side in the pressure-transmitting element 4. As a result, on the air side, air is conveyed from the pressure-transmitting element 4 into the pressure accumulator 5 and the pressure in the air accumulator 5 increases. Thereafter, the valves 11 and 15 are closed. Valves 12 and 14 are opened again, as a result of which the pressure in the pressure-transmitting element 4 can equalize. Step (b) can be repeated several times depending on the required pressure level of the air in the pressure vessel 5.
(c) When step (b) is completed, the valve 13 is closed. If a higher load of the fuel cell 1 is now required, valve 15 opens and the air that is available at higher pressure is used to supply the fuel cell 1.

(d) Finally, if the air compressor 20 delivers the required amount of air at the inlet of the fuel cell 1, the air flow from the pressure vessel 5 is reduced. Then, valve 15 is closed and valve 13 is opened. The process of filling the air tank 5 and increasing the pressure can thus begin all over again.

The fuel cell systems 10 shown in FIGS. 2 and 3 have at least one fuel cell 1, an anode-side gas feed line 2, a cathode-side gas feed line 3, and a control unit, wherein a pressure-transmitting element 4 is arranged between the anode-side and the cathode-side gas feed lines 2, 3, wherein the control unit is configured to at least partially transmit a gas pressure of the anode-side gas feed line 2 via the pressure-transmitting element 4 to the cathode-side gas feed line 3 when there is an increased power requirement for the fuel cell 1, and to cause an increase in gas pressure of the cathode-side gas feed line 3. The fuel cell systems 10 shown are particularly suitable for carrying out a method for operating a fuel cell 1, wherein the gaseous fuel is supplied to the fuel cell 1 via an anode-side gas feed line 2 and air is supplied via a cathode-side gas feed line 3, wherein the anode-side gas feed line 2 and the cathode-side gas feed line 3 are coupled via a pressure-transmitting element 4, wherein when there is an increased power requirement for the fuel cell 1, a gas pressure of the anode-side gas feed line 2 is at least partially transmitted via the pressure-transmitting element 4 to the cathode-side gas feed line 3 and causes an increase in gas pressure of the cathode-side gas feed line 3.

### LIST OF REFERENCE SYMBOLS

1 Fuel cell
1′ Cell stack
2 Anode-side gas feed line
3 Cathode-side gas feed line
4 Pressure-transmitting element
5 Pressure accumulator
6 Low pressure section
7 Pre-relaxation/high-pressure section
8 Gas discharge
9 Fuel tank
10 Fuel cell system
11 First valve
12 Second valve
13 Third valve
14 Fourth valve
15 Fifth valve
16 Section between first and second valve
17 Accumulator section
18 Hydrogen recirculation
19 Recirculation pump
20 Compressor
21 Intercooler
22 Filter
23 First valve of pre-expansion
24 Second valve of pre-expansion
25 Gas discharge valve
26 Humidifier

1. A method for operating a fuel cell comprising: supplying gaseous fuel to the fuel cell via a gas feed line on an anode side and supplying air via a gas feed line on a cathode side; coupling the anode-side gas feed line and the cathode-side gas feed line via a pressure-transmitting element; and in the event of an increased power requirement for the fuel cell, at least partially transmitting a gas pressure from the gas feed line on the anode-side via the pressure-transmitting element to the gas feed line on the cathode-side to cause an increase in a gas pressure of the cathode-side gas feed line.

2. The method according to claim 1, wherein the pressure-transmitting element has a flexible membrane or a displaceable piston.

3. The method according to claim 1, further comprising admitting compressed air from a pressure accumulator to increase the gas pressure of the gas feed line on the cathode side.

4. The method according to claim 3, further comprising refilling the pressure accumulator after the increased power requirement has ended until a target pressure of the pressure accumulator is reached, wherein an air pressure of the pressure accumulator is increased in stages up to the target pressure.

5. The method according to claim 1, wherein the anode-side gas feed line has a high-pressure section and a low-pressure section, wherein the pressure-transmitting element is connected to the high-pressure section by a first valve and to the low-pressure section by a second valve, the method further comprising opening the first valve and closing the second valve to transmit the gas pressure from the anode-side gas feed line to the cathode-side gas feed line.

6. The method according to claim 5, further comprising, after the gas pressure of the anode-side gas has been transmitted to the cathode-side gas feed line, closing the first valve and opening the second valve to supply gaseous fuel from one section between the first and second valve through the second valve of the fuel cell.

7. The method according to claim 3, further comprising refilling the pressure accumulator by at least partially transmitting the gas pressure of the anode-side gas feed line to the pressure accumulator by the pressure-transmitting element, wherein the cathode-side gas feed line has an accumulator section which is connected to the pressure-transmitting element via a third valve, is connected to the fuel cell via a fourth valve, and is connected via a fifth valve to the pressure accumulator, wherein the fourth valve is closed and the fifth valve is opened to refill the pressure accumulator in a first filling step with the third valve open, wherein the gas pressure of the anode-side gas feed line is at least partially transmitted to the accumulator by the pressure-transmitting element via the accumulator section, whereby the fourth valve is opened and the fifth valve is closed in a second filling step.

8. The method according to claim 7, further comprising, after the pressure accumulator has been refilled, closing the third valve and opening the fifth valve to admit compressed air from the pressure accumulator.

9. The method according to claim 1, further comprising pressurizing the air in the cathode-side gas feed line with a compressor, wherein an operation of the compressor with an increased compressor power causes a further additional increase in the gas pressure of the cathode-side gas feed line.

10. The method according to claim 1, wherein an air pressure at an inlet of the fuel cell is limited by a pressure regulator or a self-regulating element.

11. A fuel cell system comprising: at least one polymer electrolyte membrane fuel cell, an anode-side gas feed line a cathode-side gas feed line, and a control unit, wherein a pressure-transmitting element is arranged between the anode-side and the cathode-side gas feed lines, wherein the control unit is configured to at least partially transmit a gas pressure from the anode-side gas feed line via the pressure-transmitting element o the cathode-side gas feed line in the event of an increased power requirement for the fuel cell to cause an increase in a gas pressure of the cathode-side gas feed line.

12. The fuel cell system according to claim 11, wherein the fuel cell system has a pressure accumulator, and in the event of the increased power requirement, the control unit is configured to cause an additional increase in the gas pressure of the cathode-side gas feed line by admitting compressed air from a pressure accumulator.

13. The fuel cell system according to claim 12, wherein the pressure-transmitting element has a flexible membrane or a displaceable piston.

14. The fuel cell system according to claim 12, wherein the control unit is configured to refill the pressure accumulator after the increased power requirement has ended until a target pressure of the pressure accumulator is reached.

15. The fuel cell system according to claim 12, wherein the anode-side gas feed line has a high-pressure section and a low-pressure section, wherein the pressure-transmitting element is connected to the high-pressure section by a first valve and to the low-pressure section by a second valve, and wherein the control unit is configured to open the first valve and close the second valve to transmit the gas pressure from the anode-side gas feed line to the cathode-side gas feed line.

16. The fuel cell system according to claim 15, wherein the control unit is configured to, after the gas pressure of the anode-side gas has been transmitted to the cathode-side gas feed line, close the first valve and open the second valve to supply gaseous fuel from one section between the first and second valve through the second valve of the fuel cell.

17. The fuel cell system according to claim 12, wherein the cathode-side gas feed line has an accumulator section which is connected to the pressure-transmitting element via a third valve, is connected to the fuel cell via a fourth valve, and is connected via a fifth valve to the pressure accumulator, wherein the control unit is configured: to refill the pressure accumulator by at least partially transmitting the gas pressure of the anode-side gas feed line to the pressure accumulator by the pressure-transmitting element, close the fourth valve and open the fifth valve to refill the pressure accumulator in a first filling step with the third valve open, at least partially transmit the gas pressure of the anode-side gas feed line to the accumulator by the pressure-transmitting element via the accumulator section, and open the fourth valve and close the fifth valve in a second filling step.

18. The fuel cell system according to claim 17, wherein the control unit is configured to, after the pressure accumulator has been refilled, close the third valve and open the fifth valve to admit compressed air from the pressure accumulator.

19. The fuel cell system according to claim 12, further comprising a compressor for pressurizing the air in the cathode-side gas feed line.

20. The fuel cell system according to claim 12, further comprising a pressure regulator or a self-regulating element for limiting an air pressure at an inlet of the fuel cell.
